(19) United States
(12) Patent Application Publication
(10) Pub. No.: US 2003/0092446 A1
(43) Pub. Date: May 15, 2003

(54) System and method for connecting incoming calls to disposable cell phones

(76) Inventor: Roger Boivin, Melissa, TX (US)

Correspondence Address: Edward A. Pennington, Esq., Swidler Berlin Shereff Friedman, LLP, Suite 300, 3000 K Street, N.W., Washington, DC, 20007-5116, US

(21) Appl. No.: 10/290,360

(22) Filed: Nov. 8, 2002

Related U.S. Application Data
(60) Provisional application No. 60/331,177, filed on Nov. 9, 2001.

(51) Int. Cl. H04Q 7/20

(52) U.S. Cl. 455/445; 455/433

(57) ABSTRACT

A system and method for connecting an incoming call to a mobile telephone, such as a recyclable/disposable mobile telephone. A system for connecting an incoming call to a mobile telephone comprises a server platform connected to a public switch telephone network and to a mobile switching center of a mobile telephone network and operable to receive calls from the public switch telephone network and place calls to mobile telephones in the mobile telephone network, the server platform comprising a server operable to request a Temporary Local Directory Number (TLDN) or Temporary Mobile Identification Number (TMSI) Temporary Local Directory Number (TLDN) or Temporary Mobile Identification Number (TMSI) assignment for the mobile telephone from the mobile switching center, receive the Temporary Local Directory Number (TLDN) or Temporary Mobile Identification Number (TMSI) Number from the mobile switching center, and route the call to the mobile telephone using Temporary Local Directory Number (TLDN) or Temporary Mobile Identification Number (TMSI). The mobile telephone is a recyclable/disposable telephone.

### CROSS-REFERENCE TO RELATED APPLICATIONS

The benefit under 35 U.S.C. §119(e) of provisional application No. 60/331,177, filed Nov. 9, 2001, is hereby claimed.

### FIELD OF THE INVENTION

The present invention relates to a system and method for connecting incoming calls to disposable cell phones using a Temporary Local Directory Number (TLDN) or Temporary Mobile Identification Number (TMSI)s or a Temporary Mobile Subscriber Identification Number (TLDN/TMSI) and treating disposable phones as roamers regardless of location.

### BACKGROUND OF THE INVENTION

Mobile telecommunications, such as that provided by wireless telephones, has become increasingly popular and widespread. With this increasing popularity has come a proliferation of mobile telephone plans, with a proliferation of fees, features, and restrictions. Most such plans require a relatively large initial investment and a continuing monthly fee, regardless of usage. While such plans may meet the needs of many users, they do not meet the needs of many other users. For example, a user may desire a mobile telephone to be available for emergency use only. Likewise, a user may desire short-term service while on a trip or for visitors while being visited. Kids, teens, college students, low-income individuals, and people with blemished credit or no credit history and senior citizens are other demographic groups who will find the easy-to-use, inexpensive disposable cell phone very appealing. Another potential market includes immigrants who live on low incomes, do not have established credit, or do not care to buy expensive cell phones. These users are not really compatible with the typical initial investment and continuing fee required by most mobile telephone plans. In these and many other situations, a need arises for a mobile telephone that requires a reasonable initial investment and no continuing fee.

Conventional solutions to such needs include pay-per-use, prepaid, and rental mobile telephones. However, these solutions have disadvantages in that they typically still require relatively large initial investments, contracts, and/or deposits on the part of the user. A better solution is the recyclable/disposable mobile telephone, which requires only a reasonable initial investment by the user and does not require contracts or deposits.

### SUMMARY OF THE INVENTION

The present invention is a system and method for connecting an incoming call to a mobile telephone such as a recyclable/disposable mobile telephone. In one embodiment of the present invention, a system for connecting an incoming call to a mobile telephone comprises a server platform connected to a public switch telephone network and to a mobile switching center of a mobile telephone network and operable to receive calls from the public switch telephone network and place calls to mobile telephones in the mobile telephone network, the server platform comprising a server operable to request a Temporary Local Directory Number (TLDN) or Temporary Mobile Identification Number (TMSI) Temporary Local Directory Number (TLDN) or Temporary Mobile Identification Number (TMSI) assignment for the mobile telephone from the mobile switching center, receive the Temporary Local Directory Number (TLDN) or Temporary Mobile Identification Number (TMSI) Number from the mobile switching center, and route the call to the mobile telephone using Temporary Local Directory Number (TLDN) or Temporary Mobile Identification Number (TMSI). The mobile telephone is a recyclable/disposable telephone.

In one aspect of the present invention, the server may be operable to request a Temporary Local Directory Number (TLDN) or Temporary Mobile Identification Number (TMSI) Number by transmitting a request for a Temporary Local Directory Number (TLDN) or Temporary Mobile Identification Number (TMSI) assignment to a mobile switching center based on a location of the mobile telephone and on identification information of the mobile telephone. The identification information of the mobile telephone may comprise a Mobile Identification Number. The server may be further operable to request a Temporary Local Directory Number (TLDN) or Temporary Mobile Identification Number (TMSI) assignment by obtaining the location of the mobile telephone from the mobile switching center. The server may be operable to transmit a request for a Temporary Local Directory Number (TLDN) or Temporary Mobile Identification Number (TMSI) assignment by transmitting an Interim Standard 41 (IS-41) Routing Request Message (ROUTEREQ) to the mobile switching center using Signaling System 7 (SS7) or by transmitting a Mobile Application Part (MAP) message using the Global System for Mobile communication (GSM) Customized Applications for Mobile Network Enhanced Logic CAMEL protocol. The identification information of the mobile telephone may comprise a Mobile Identification Number. The server may be operable to request a Temporary Local Directory Number (TLDN) or Temporary Mobile Identification Number (TMSI) assignment by obtaining the location of the mobile telephone from the mobile switching center.

In one aspect of the present invention, the server platform may further comprise an interactive voice response unit operable to prompt a caller who placed the incoming call to enter the number of the mobile telephone. The server may be further operable to receive the number of the mobile telephone from the caller. The incoming call may be placed to a toll-free access number, such as a 1-800 number. The server may be further operable to validate the received the number of the mobile telephone. The server platform may further comprise a database containing call duration information relating to the mobile telephone. The server may be further operable to access the database to determine a call duration balance relating to the mobile telephone and connect the call to the mobile telephone, if there is a call duration balance remaining. The server may be further operable to receive notification of termination of the call and access the database to decrement the call duration balance based on the time used by the call. The server may be further operable to disconnect the call if the call is not completed when an amount of time equal to the call duration balance has elapsed.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of a typical mobile communications network, which may function in conjunction with the present invention.

FIG. 2 is an exemplary block diagram of a mobile communications network, in which the present invention may be implemented.

FIG. 3 is an exemplary flow diagram of a process of operation of the present invention.

FIG. 4 is an exemplary block diagram of a server system shown in FIG. 2.

### DETAILED DESCRIPTION OF THE INVENTION

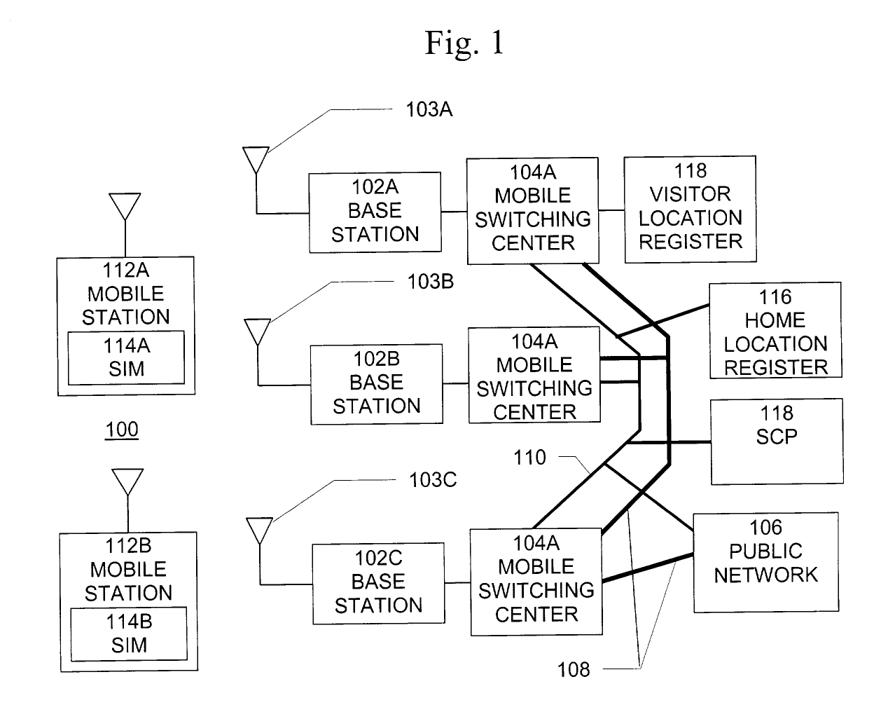

An exemplary block diagram of a typical mobile communications network 100, which may function in conjunction with the present invention, is shown in FIG. 1. Such a mobile network includes a plurality of base stations, such as base stations 102A-C. Each base station, such as base station 102A, typically includes a plurality of base station transceivers, which are part of a base station cluster controlled by a single base station controller. Each base station transceiver transmits and receives radio signals on its corresponding antenna 103A-C and each such transceiver antenna unit covers an area known as a cell. For much of the network, base station transceivers are organized in a seven cell or twelve cell repeat pattern with tri-sectored coverage for each. Thus, seven or twelve base station transceivers are typically connected to each base station controller. Most base station transceivers have between 20 and 30 voice channels with one signaling channel carrying all of the paging and access functions per cell.

Each base station, such as base station 102A, is connected to a mobile switching center (MSC), such as MSC 104A. MSC 104A is a digital switching system with a distributed control architecture especially adapted for operation in the cellular environment. The base stations 102A-C are typically connected to their corresponding MSCs 104A-C and the public (landline) telephone network 106 over digital lines 108. The MSCs 104A-C handle the switching of call traffic between base stations and the landline telephone network, public network 106. MSCs 104A-C are also connected by a signaling network 110, over which a variety of signaling messages are communicated.

The system also includes a plurality of mobile telephones, such as mobile telephones 112A-B, which receive and transmit radio signals with the antenna 103A-C of the base station 102A-C with which the mobile telephone is communicating. Each mobile telephone 112A-B may include a subscriber identity module (SIM), such as SIM 114A-B. Designed to be inserted into a mobile telephone, a SIM or “smart” card contains subscriber-related data, such as phone numbers, service details, and memory for storing messages. With a SIM card, calls can be made from any valid mobile phone because the subscriber data—not the telephone's internal serial number—is used to make the call.

Associated with mobile communications network 100 is home location register (HLR) 116. HLR 116 stores management data relating to all of the mobile telephones 112A-B for which network 100 is the home network. Each MSC 104A-C is associated with an HLR 116 in the network. In principle there need be only one HLR 116 for the entire mobile network. In practice, there are generally several so as to accommodate the large quantity of data, which is required to be stored in the HLR 116. This data includes the international mobile station identity (IMSI), the mobile station profile of capacities and services unique to the mobile telephone 112A-B, and the location of the mobile telephone 112A-B within the overall mobile network. HLR 116 is connected over signaling network 110 to the MSCs 104A-C in the network.

Associated with each MSC 104A-C is a visitor location register (VLR) 118. Each MSC 104A-C typically has its own VLR 118, but this is not required. VLR 118 stores selected data relating to mobile telephones 112A-B that are visiting within the network associated with VLR 118 and its MSC 104A-C. The data stored in VLR 118 is transferred from the home location register of the home network to VLR 118 for each mobile telephone 112A-B within the network of the VLR. This data can include the international mobile station identity (IMSI), the mobile station international ISDN number, and other information, including the current geographic location of the mobile telephone 112A-B, and the services available to the mobile telephone 112A-B, for example supplementary voice services or data services.

The VLR servicing a geographic area is continually updated with the locations of every mobile telephone within its service area as each mobile telephone registers or otherwise communicates with the system. In addition, the HLR is updated with the current serving MSC of each active mobile telephone allocated to it. This location is typically in the form of the particular cell—base station, base station transceiver, and antenna—in which the mobile telephone is located.

Mobile network 100 may also include service control point (SCP) 118. SCP 118 is a database that supplies the translation and routing data needed to provide advanced network services in signaling network 110. SCP 118 translates special service numbers, such as 800 numbers, to provide the required routing number.

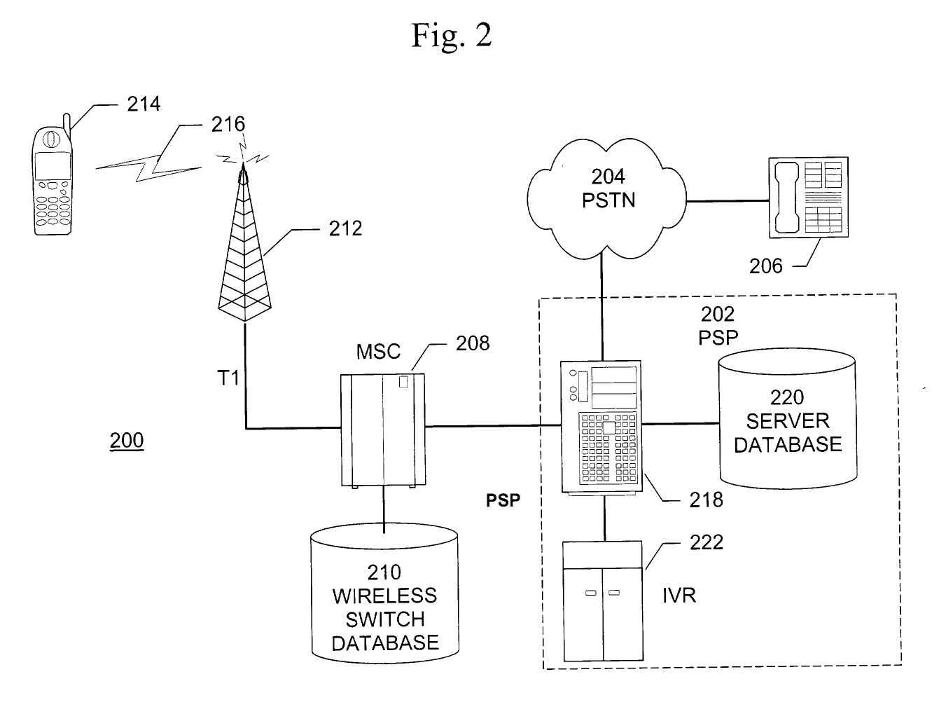

An exemplary block diagram of a mobile communications network 200, in which the present invention may be implemented, is shown in FIG. 2. Network 200 includes prepaid server platform (PSP) 202, public switch telephone network (PSTN) 204, telephone station 206, mobile switching center (MSC) 208, wireless switch database 210, base station 212, and mobile telephone 214. The network shown in FIG. 2 is merely an example. One of skill in the art would recognize that a network in which the present invention may be implemented may include multiple instances of elements shown in FIG. 2, as well as additional elements, such as those shown in FIG. 1.

Mobile telephone 214 receives and transmits radio signals over radio frequency link 216 with the antenna of the base station 212 with which the mobile telephone is communicating. Preferably, mobile telephone 214 is a disposable/recyclable wireless or cellular telephone (RDP) and will be referred to as such for this example.

Base station 212 is connected to MSC 208. MSC 208 is a digital switching system with a distributed control architecture especially adapted for operation in the cellular environment. Base stations 212 is typically connected MSC 208 over digital lines, such as a Ti line. MSC 208 handles the switching of call traffic between base station 212 and PSP 202.

MSC 208 is connected to wireless switch database 210 and PSP 202. PSP 202 includes prepaid service server 218, server database system 220, and interactive voice response (IVR) unit 222. Server 218 handles calls placed between mobile telephone 214 and PSTN 204. Server database system 220 stores data needed by server 218 in order to handle the calls and perform the appropriate billing. IVR 222 provides interactive voice response to callers in order to facilitate the handling of calls by server 218. As one of skill in the art would recognize, server database system 220 and/or IVR 222 may be included in server 218, or they may be implemented separately from server 218. The present invention contemplates any and all such arrangements.

One-time use recyclable/disposable cell phones (RDP) can receive calls by using a Temporary Local Directory Number (TLDN) and/or a Temporary Mobile Station Identity (TMSI) and treating a recyclable/disposable phone as a roamer. The TLDN is a number that is temporarily assigned to a roaming mobile telephone, to enable call delivery to a mobile telephone during roaming. A mobile telephone is considered to be roaming when it is outside its home service area. A recyclable/disposable phone need not have a home service area if it is treated as a roamer regardless of its location. This connection method disposable phone method uses a prepaid server platform (PSP) to track and handle calls.

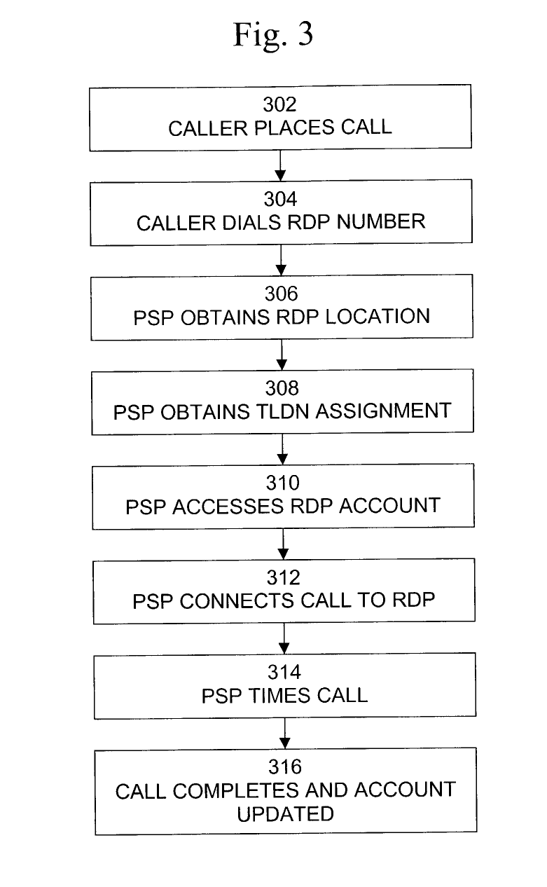

An exemplary flow diagram of a process 300 of operation of the present invention is shown in FIG. 3. It is best viewed in conjunction with FIG. 2. Process 300 begins with step 302, in which a call is placed to a number that connects the caller to PSP 202. Typically, this number is a toll-free access number, such as a 1-800 number. Within PSP 202, the call is connected to server 218. Upon connection to PSP 202, IVR 222 interacts with the caller and prompts for the number of RDP 214.

In step 304, the caller dials the number of RDP 214 and this number is captured by server 218. In step 306, server 218 confirms that the dialed number of RDP 214 is valid, then interrogates the MSC 208 to obtain the location of RDP 214. MSC 208 communicates with the HLR of RDP 214 and obtains the location of RDP 214. MSC 208 then transmits the location of RDP 214 to server 218.

In step 308, server 218 transmits a request for a Temporary Local Directory Number (TLDN) or Temporary Mobile Identification Number (TMSI)s assignment for RDP 214 to MSC 208. The request is based on the received location of RDP 214 and on the Mobile Identification Number (MIN) of RDP 214. The MIN is a typically ten digit number that is used to uniquely identify a mobile telephone, such as an Advanced Mobile Phone Service (AMPS) or Code Division Multiple Access (CDMA) mobile telephone. For example, server 218 may transmit an Interim Standard 41 (IS-41) Routing Request Message (ROUTEREQ) to MSC 208 using the well-known Signaling System 7 (SS7). As another example, server 218 may transmit a Mobile Application Part (MAP) message using the Global System for Mobile communication (GSM) Customized Applications for Mobile Network Enhanced Logic CAMEL protocol. GSM is a digital mobile telephone system that is widely used in Europe and other parts of the world. GSM uses a variation of time division multiple access (TDMA). CAMEL is a application program interface that works with GSM and allows roaming mobile telephones access to intelligent network services. MSC 208 returns a TLDN that allows the call to be terminated to RDP 214 for the duration of the call.

In step 310, server 218 accesses server database system 220 and obtains information relating to the account associated with RDP 214. In particular, server 220 determines the balance of the call duration minutes remaining in the account information database stored in server database system 220. If some call duration minutes remain in the account, a timer is assigned to the call and in step 312, server 218 originates a call to RDP 214 using the TLDN. The call is connected through MSC 208, base station 212, and over the air to RDP 214. In step 314, server 218 waits for RDP 214 to answer the call and then times the call using the timer assigned in step 310.

In step 316, when the call is completed by either the called or calling party, the MSC notifies the PSP of call termination. Typically, this notification is sent using an IS-41 message. Server 218 accesses server database 220 and decrements the minutes used in the account associated with RDP 214. If the call is not completed when the timer kept by server 218 runs out, server 218 transmits a message to MSC 208 instructing MSC 208 to disconnect the call. Server 218 then accesses server database 220 and updates the account associated with RDP 214 to show no minutes left, preventing further calls from RDP 214.

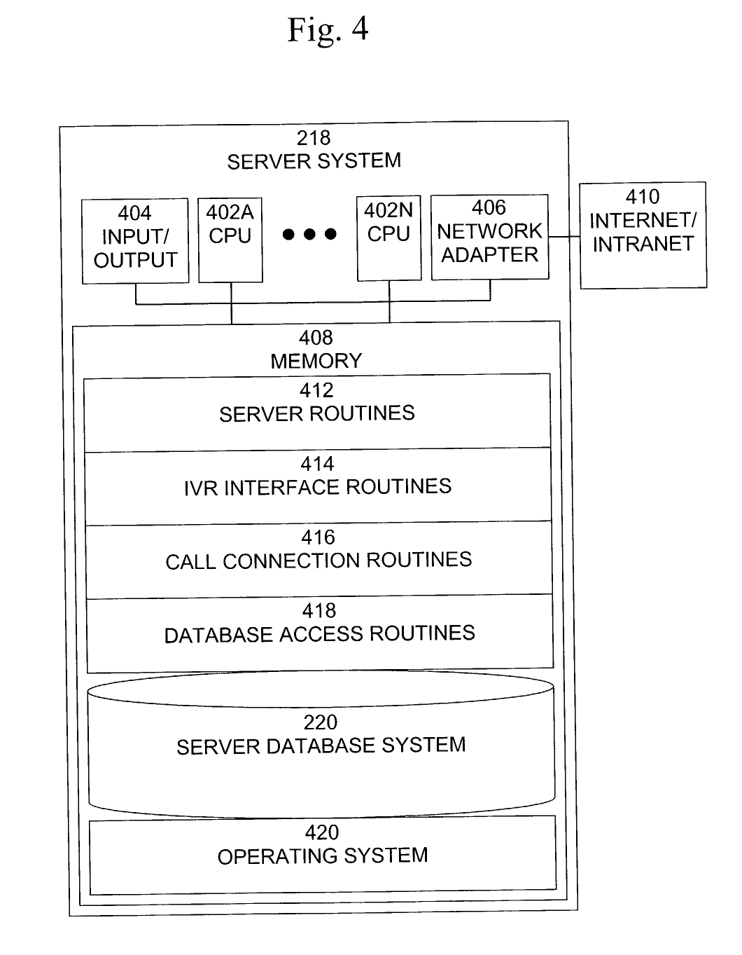

An exemplary block diagram of a server system 400 shown in FIG. 2, is shown in FIG. 4. System 400 is typically a programmed general-purpose computer system, such as a personal computer, workstation, server system, and minicomputer or mainframe computer. System 400 includes one or more processors (CPUs) 402A-402N, input/output circuitry 404, network adapter 406, and memory 408. CPUs 402A-402N execute program instructions in order to carry out the functions of the present invention. Typically, CPUs 402A-402N are one or more microprocessors, such as an INTEL PENTIUM® processor. FIG. 4 illustrates an embodiment in which System 400 is implemented as a single multi-processor computer system, in which multiple processors 402A-402N share system resources, such as memory 408, input/output circuitry 404, and network adapter 406. However, the present invention also contemplates embodiments in which System 400 is implemented as a plurality of networked computer systems, which may be single-processor computer systems, multi-processor computer systems, or a mix thereof.

Input/output circuitry 404 provides the capability to input data to, or output data from, database/System 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces database/System 400 with Internet/intranet 410. Internet/intranet 410 may include one or more standard local area network (LAN) or wide area network (WAN), such as Ethernet, Token Ring, the Internet, or a private or proprietary LAN/WAN.

Memory 408 stores program instructions that are executed by, and data that are used and processed by, CPU 402 to perform the functions of system 400. Memory 408 may include electronic memory devices, such as random-access memory (RAM), read-only memory (ROM), programmable read-only memory (PROM), electrically erasable programmable read-only memory (EEPROM), flash memory, etc., and electromechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the example shown in FIG. 4, memory 408 includes server routines 412, IVR interface routines 414, call connection routines 416, database access routines 418, and operating system 428. Server system 218 may also include server database system 220. one of skill in the art would recognize that these functions, along with the memory contents related to those functions, may be included on one system, or may be distributed among a plurality of systems, based on well-known engineering considerations. The present invention contemplates any and all such arrangements. For example, server database system 220 and/or IVR 222 may be included in server 218, or they may be implemented separately from server 218.

Server routines 412 include software that implements the functionality of prepaid server platform 202, shown in FIG. 1. IVR interface routines 414 provide the capability to interface an IVR, such as IVR 222, with server system 218 and to interoperate with the IVR. Call connection routines 416 provide the capability to connect calls with mobile telephones, such as RDP 214, in order to perform process 300, shown in FIG. 3. Database access routines provide the capability to access server database system 220, in order to perform process 300. Operating system 420 provides overall system functionality.

As shown in FIG. 4, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and WINDOWS®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multitasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for connecting an incoming call to a mobile telephone comprising the steps of:
requesting a Temporary Local Directory Number (TLDN) or Temporary Mobile Identification Number (TMSI) assignment for the mobile telephone from a mobile switching center;
receiving the Temporary Local Directory Number (TLDN) or Temporary Mobile Identification Number (TMSI) from the mobile switching center; and
routing the call to the mobile telephone using the Temporary Local Directory Number (TLDN) or Temporary Mobile Identification Number (TMSI).

2. The method of claim 1, wherein the mobile telephone is a recyclable/disposable telephone.

3. The method of claim 2, wherein the step of requesting a Temporary Local Directory Number (TLDN) or Temporary Mobile Identification Number (TMSI) assignment comprises the step of:
transmitting a request for a Temporary Local Directory Number (TLDN) or Temporary Mobile Identification Number (TMSI) assignment based on a location of the mobile telephone and on identification information of the mobile telephone.

4. The method of claim 3, wherein the identification information of the mobile telephone comprises a Mobile Identification Number.

5. The method of claim 3, wherein the step of requesting a Temporary Local Directory Number (TLDN) or Temporary Mobile Identification Number (TMSI) assignment further comprises the step of:
obtaining the location of the mobile telephone from the mobile switching center.

6. The method of claim 3, wherein the step of transmitting a request for a Temporary Local Directory Number (TLDN) or Temporary Mobile Identification Number (TMSI) assignment comprises the step of:
transmitting an Interim Standard 41 (IS-41) Routing Request Message (ROUTEREQ) to the mobile switching center using Signaling System 7 (SS7). or a Mobile Application Protocol (MAP) message using Customized Applications for Mobile Network Enhanced Logic (CAMEL).

7. The method of claim 6, wherein the identification information of the mobile telephone comprises a Mobile Identification Number.

8. The method of claim 7, wherein the step of requesting a Temporary Local Directory Number (TLDN) or Temporary Mobile Identification Number (TMSI) assignment further comprises the step of:
obtaining the location of the mobile telephone from the mobile switching center.

9. The method of claim 2, further comprising the steps of:
receiving the incoming call;
prompting a caller who placed the incoming call to enter a number of a mobile telephone; and
receiving the number of the mobile telephone from the caller.

10. The method of claim 9, wherein the incoming call is placed to a toll-free access number, such as a 1-800 number.

11. The method of claim 9, further comprising the steps of:
validating the received number of the mobile telephone.

12. The method of claim 11, further comprising the steps of:
determining a call duration balance relating to the mobile telephone; and
connecting the call to the mobile telephone, if there is a call duration balance remaining.

13. The method of claim 12, further comprising the steps of:
receiving notification of termination of the call; and
decrementing the call duration balance based on the time used by the call.

14. The method of claim 13, further comprising the step of:
disconnecting the call if the call is not completed when an amount of time equal to the call duration balance has elapsed.

15. A system for connecting an incoming call to a mobile telephone comprising:
a processor operable to execute computer program instructions;
a memory operable to store computer program instructions executable by the processor; and
computer program instructions stored in the memory and executable to perform the steps of:
requesting a Temporary Local Directory Number (TLDN) or Temporary Mobile Identification Number (TMSI) assignment for the mobile telephone from a mobile switching center;
receiving the Temporary Local Directory Number (TLDN) or Temporary Mobile Identification Number (TMSI) from the mobile switching center; and
routing the call to the mobile telephone using the Temporary Local Directory Number (TLDN) or Temporary Mobile Identification Number (TMSI).

16. The system of claim 15, wherein the mobile telephone is a recyclable/disposable telephone.

17. The system of claim 16, wherein the step of requesting a Temporary Local Directory Number (TLDN) or Temporary Mobile Identification Number (TMSI) assignment comprises the step of:
transmitting a request for a Temporary Local Directory Number (TLDN) or Temporary Mobile Identification Number (TMSI) assignment based on a location of the mobile telephone and on identification information of the mobile telephone.

18. The system of claim 17, wherein the identification information of the mobile telephone comprises a Mobile Identification Number.

19. The system of claim 17, wherein the step of requesting a Temporary Local Directory Number (TLDN) or Temporary Mobile Identification Number (TMSI) assignment further comprises the step of:
obtaining the location of the mobile telephone from the mobile switching center.

20. The system of claim 17, wherein the step of transmitting a request for a Temporary Local Directory Number (TLDN) or Temporary Mobile Identification Number (TMSI) assignment comprises the step of:
transmitting an Interim Standard 41 (IS-41) Routing Request Message (ROUTEREQ) to the mobile switching center using Signaling System 7 (SS7) or a Mobile Application Protocol (MAP) message using Customized Applications for Mobile Network Enhanced Logic (CAMEL).

21. The system of claim 20, wherein the identification information of the mobile telephone comprises a Mobile Identification Number.

22. The system of claim 21, wherein the step of requesting a Temporary Local Directory Number (TLDN) or Temporary Mobile Identification Number (TMSI) assignment further comprises the step of:
obtaining the location of the mobile telephone from the mobile switching center.

23. The system of claim 16, further comprising the steps of:
receiving the incoming call;
prompting a caller who placed the incoming call to enter a number of a mobile telephone; and
receiving the number of the mobile telephone from the caller.

24. The system of claim 23, wherein the incoming call is placed to a toll-free access number, such as a 1-800 number.

25. The system of claim 23, further comprising the steps of:
validating the received number of the mobile telephone.

26. The system of claim 25, further comprising the steps of:
determining a call duration balance relating to the mobile telephone; and
connecting the call to the mobile telephone, if there is a call duration balance remaining.

27. The system of claim 26, further comprising the steps of:
receiving notification of termination of the call; and
decrementing the call duration balance based on the time used by the call.

28. The system of claim 27, further comprising the step of:
disconnecting the call if the call is not completed when an amount of time equal to the call duration balance has elapsed.

29. A computer program product for connecting an incoming call to a mobile telephone comprising:
a computer readable medium;
computer program instructions, recorded on the computer readable medium, executable by a processor, for performing the steps of
requesting a Temporary Local Directory Number (TLDN) or Temporary Mobile Identification Number (TMSI) assignment for the mobile telephone from a mobile switching center;
receiving the Temporary Local Directory Number (TLDN) or Temporary Mobile Identification Number (TMSI) from the mobile switching center; and
routing the call to the mobile telephone using the Temporary Local Directory Number (TLDN) or Temporary Mobile Identification Number (TMSI).

30. The computer program product of claim 29, wherein the mobile telephone is a recyclable/disposable telephone.

31. The computer program product of claim 30, wherein the step of requesting a Temporary Local Directory Number (TLDN) or Temporary Mobile Identification Number (TMSI) assignment comprises the step of:
transmitting a request for a Temporary Local Directory Number (TLDN) or Temporary Mobile Identification Number (TMSI) assignment based on a location of the mobile telephone and on identification information of the mobile telephone.

32. The computer program product of claim 31, wherein the identification information of the mobile telephone comprises a Mobile Identification Number.

33. The computer program product of claim 31, wherein the step of requesting a Temporary Local Directory Number (TLDN) or Temporary Mobile Identification Number (TMSI) assignment further comprises the step of:
obtaining the location of the mobile telephone from the mobile switching center.

34. The computer program product of claim 31, wherein the step of transmitting a request for a Temporary Local Directory Number (TLDN) or Temporary Mobile Identification Number (TMSI) assignment comprises the step of:
transmitting an Interim Standard 41 (IS-41) Routing Request Message (ROUTEREQ) to the mobile switching center using Signaling System 7 (SS7).

35. The computer program product of claim 34, wherein the identification information of the mobile telephone comprises a Mobile Identification Number.

36. The computer program product of claim 35, wherein the step of requesting a Temporary Local Directory Number (TLDN) or Temporary Mobile Identification Number (TMSI) assignment further comprises the step of:
obtaining the location of the mobile telephone from the mobile switching center.

37. The computer program product of claim 30, further comprising the steps of:
receiving the incoming call;
prompting a caller who placed the incoming call to enter a number of a mobile telephone; and
receiving the number of the mobile telephone from the caller.

38. The computer program product of claim 37, wherein the incoming call is placed to a toll-free access number, such as a 1-800 number.

39. The computer program product of claim 37, further comprising the steps of:
validating the received number of the mobile telephone.

40. The computer program product of claim 39, further comprising the steps of:
determining a call duration balance relating to the mobile telephone; and
connecting the call to the mobile telephone, if there is a call duration balance remaining.

41. The computer program product of claim 40, further comprising the steps of:
receiving notification of termination of the call; and
decrementing the call duration balance based on the time used by the call.

42. The computer program product of claim 41, further comprising the step of:
disconnecting the call if the call is not completed when an amount of time equal to the call duration balance has elapsed.

43. A system for connecting an incoming call to a mobile telephone comprising:
a server platform connected to a public switch telephone network and to a mobile switching center of a mobile telephone network and operable to receive calls from the public switch telephone network and place calls to mobile telephones in the mobile telephone network, the server platform comprising:
a server operable to request a Temporary Local Directory Number (TLDN) or Temporary Mobile Identification Number (TMSI) assignment for the mobile telephone from the mobile switching center, receive the Temporary Local Directory Number (TLDN) or Temporary Mobile Identification Number (TMSI) from the mobile switching center, and route the call to the mobile telephone using the Temporary Local Directory Number (TLDN) or Temporary Mobile Identification Number (TMSI).

44. The system of claim 43, wherein the mobile telephone is a recyclable/disposable telephone.

45. The system of claim 44, wherein the server is operable to request a Temporary Local Directory Number (TLDN) or Temporary Mobile Identification Number (TMSI) by transmitting a request for a Temporary Local Directory Number (TLDN) or Temporary Mobile Identification Number (TMSI) assignment to a mobile switching center based on a location of the mobile telephone and on identification information of the mobile telephone.

46. The system of claim 45, wherein the identification information of the mobile telephone comprises a Mobile Identification Number.

47. The system of claim 45, wherein the server is further operable to request a Temporary Local Directory Number (TLDN) or Temporary Mobile Identification Number (TMSI) assignment by obtaining the location of the mobile telephone from the mobile switching center.

48. The system of claim 45, wherein the server is operable to transmit a request for a Temporary Local Directory Number (TLDN) or Temporary Mobile Identification Number (TMSI) assignment by transmitting an Interim Standard 41 (IS-41) Routing Request Message (ROUTEREQ) to the mobile switching center using Signaling System 7 (SS7) or a Mobile Application Part (MAP) message using Global System for Mobile communication (GSM) Customized Applications for Mobile Network Enhanced Logic (CAMEL) protocol.

49. The system of claim 48, wherein the identification information of the mobile telephone comprises a Mobile Identification Number.

50. The system of claim 49, wherein the server is operable to request a Temporary Local Directory Number (TLDN) or Temporary Mobile Identification Number (TMSI) assignment by obtaining the location of the mobile telephone from the mobile switching center.

51. The system of claim 44, wherein the server platform further comprises an interactive voice response unit operable to prompt a caller who placed the incoming call to enter a number of the mobile telephone.

52. The system of claim 51, wherein the server is further operable to receive the number of the mobile telephone from the caller.

53. The system of claim 52, wherein the incoming call is placed to a toll-free access number, such as a 1-800 number.

54. The system of claim 52, wherein the server is further operable to validate the received number of the mobile telephone.

55. The system of claim 54, wherein the server platform further comprises a database comprising call duration information relating to the mobile telephone.

56. The system of claim 55, wherein the server is further operable to access the database to determine a call duration balance relating to the mobile telephone and connect the call to the mobile telephone, if there is a call duration balance remaining.

57. The system of claim 56, wherein the server is further operable to receive notification of termination of the call and access the database to decrement the call duration balance based on the time used by the call.

58. The system of claim 57, wherein the server is further operable to disconnect the call if the call is not completed when an amount of time equal to the call duration balance has elapsed.
